(19) United States
(12) Patent Application Publication
(10) Pub. No.: US 2016/0349509 A1
(43) Pub. Date: Dec. 1, 2016

(54) MIXED-REALITY HEADSET

(71) Applicant: Microsoft Technology Licensing, LLC, Redmond, WA (US)

(72) Inventors: Jaron Lanier, Berkeley, CA (US); Ryan Asdourian, Seattle, WA (US); Josh Hudman, Issaquah, WA (US); Dawson Yee, Medina, WA (US); Patrick Therien, Bothell, WA (US)

(21) Appl. No.: 14/721,351

(22) Filed: May 26, 2015

(51) Int. Cl. G02B 27/01; G02B 27/00; G06T 19/20; G06T 11/00; G06T 19/00

(52) U.S. Cl. CPC G02B 27/0172; G06T 11/001; G06T 19/006; G06T 19/20; G02B 27/0176; G02B 27/0093; G06T 2207/10016; G06T 2215/16; G02B 2027/0169; G02B 2027/0118; G02B 2027/0123; G02B 2027/0138; G02B 2027/0134; G02B 2027/014

(57) ABSTRACT

A “Mixed-Reality Headset” include an attachment mechanism for a smartphone or other portable computing device. A combination of the smartphone display with various internal headset optics present both augmented reality (AR) and virtual reality (VR). The Mixed-Reality Headset provides low cost, high performance, easy to use AR and VR experiences with unmodified smartphone hardware, thereby improving user experience and interaction with smartphones. In various implementations, applications associated with the Mixed-Reality Headset consider user movement and tracking (e.g., head, eye, hands, body) and real-world environmental mapping when rendering AR and VR content. The Mixed-Reality Headset easily and quickly transitions between AR and VR scenarios by causing transparent optical members to either pass light or block light, thereby either showing or hiding views of the real world. Additional reflective members are applied to enable smartphone cameras to capture real-world environmental views around the user and/or to track user gaze or eye movements.

### BACKGROUND

Augmented reality (AR) devices overlay augmented content, such as 3D content, 2D overlays, text, virtual objects, etc., onto a user's view of the surrounding real-world environment. In other words, an AR device often shows a view of the real world that has been augmented to include either or both static and dynamic 2D or 3D content. In contrast, virtual reality (VR) devices generally present the user with a completely virtual 2D or 3D environment in a way that replaces the user's view of the surrounding real-world environment. A variety of smartphone-based VR devices are implemented as head-worn devices that position smartphone displays directly in the users field of view behind lenses for each eye. Such devices typically replace the user's field of view with a virtual view via the display screen of the smartphone to present the user with head-worn wide-angle virtual displays.

### SUMMARY

The following Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Further, while certain disadvantages of other technologies may be noted or discussed herein, the claimed subject matter is not intended to be limited to implementations that may solve or address any or all of the disadvantages of those other technologies. The sole purpose of this Summary is to present some concepts of the claimed subject matter in a simplified form as a prelude to the more detailed description that is presented below.

In general, a “Mixed-Reality Headset,” as described herein, provides a dock, mount, or other attachment mechanism for a portable computing device with an integral display screen. The Mixed-Reality Headset applies the attached portable computing device to provide either or both augmented reality (AR) and virtual reality (VR) via a combination of internal headset optics with a display screen of the portable computing device. Examples of portable computing devices operable with the Mixed-Reality Headset include, but are not limited to, smartphones, media players, gaming devices, mini-tablet type computers, eReaders, small computing devices with integral displays, or simply a display screen or device capable of receiving and presenting video content. However, for purposes of explanation, the following discussion will refer to the use a smartphone coupled to the Mixed-Reality Headset for presentation of AR and VR content. Any discussion of smartphones in this context applies equally to some or all of the various portable computing devices operable with the Mixed-Reality Headset.

In various implementations, the Mixed-Reality Headset scales from simple AR and VR scenarios with little user movement or interaction to fully immersive AR and VR scenarios with optional user movement and tracking (e.g., head, eye, hands, and body) and optional real-world environmental mapping and interpretation for integration of real-world content into either or both AR and VR scenarios.

Further, in various implementations, the Mixed-Reality Headset easily and quickly transitions between AR and VR scenarios by causing one or more transparent optical members of the Mixed-Reality Headset to either pass light (e.g., real world remains visible to present AR content) or block light (e.g., real world not visible to present VR content). In other implementations, the Mixed-Reality Headset provides various reflective members configured to enable one or more smartphone cameras to capture views of the real-world environment around the user and/or to track movements of one or more of the user's eyes.

For example, in various implementations, the Mixed-Reality Headset includes a frame or other securing mechanism that is configured to secure a display screen of a smartphone or other portable computing device in a position outside a central field of view of a user. In other words, the central field of view of a user remains open to receiving views of the real world. Further, the Mixed-Reality Headset includes one or more transparent optical members configured to transmit light through a partial reflector of the headset. More specifically, the transparent optical members are positioned to allow frontal and optional peripheral vision while wearing the headset. In addition, a first reflective member of the Mixed-Reality Headset is positioned to reflect images (towards a user's eyes) rendered on the display screen after passing through the partial reflector. Finally, a per-eye optical controller of the Mixed-Reality Headset is configured to align one or more virtual objects being rendered on the display screen with one or more real-world objects visible through the partial reflector and the transparent optical member, thereby improving alignment of AR content.

The Mixed-Reality Headset provides various techniques for enabling smartphones or other portable computing devices to present AR and/or VR experiences via various combinations of headset optics. In addition to the benefits described above, other advantages of the Mixed-Reality Headset will become apparent from the detailed description that follows hereinafter.

### BRIEF DESCRIPTION OF THE DRAWINGS

The specific features, aspects, and advantages of the claimed subject matter will become better understood with regard to the following description, appended claims, and accompanying drawings where:

FIG. 1 illustrates a perspective view of an exemplary implementation of a “Mixed-Reality Headset” for enabling smartphones or other portable computing devices to present augmented reality (AR) and/or virtual reality (VR) content and experiences via various combinations of headset optics.

FIG. 2 illustrates a user participating in AR and/or VR environments via a head-worn Mixed-Reality Headset with optional audio headphones, as described herein.

FIG. 3 provides an exemplary architectural flow diagram that illustrates physical components and program modules for effecting various implementations of the Mixed-Reality Headset, as described herein.

FIG. 4 illustrates an exemplary functional diagram of various implementations of internal Mixed-Reality Headset optics, as described herein.

FIG. 5 illustrates an exemplary functional diagram of various implementations of internal Mixed-Reality Headset optics, as described herein.

FIG. 6 illustrates an exemplary functional diagram of various implementations of internal Mixed-Reality Headset optics, as described herein.

FIG. 7 illustrates an exemplary functional diagram of various implementations of internal Mixed-Reality Headset optics, as described herein.

FIG. 8 illustrates an exemplary illustration of the application of polarizing filters of controlling visibility of light through transparent optical members of various implementations of the Mixed-Reality Headset Optics, as described herein.

FIG. 9 illustrates a general system flow diagram that illustrates exemplary various exemplary implementations of the Mixed-Reality Headset, as described herein.

FIG. 10 is a general system diagram depicting a simplified general-purpose computing device having simplified computing and I/O capabilities and a display screen for use in effecting various implementations of the Mixed-Reality Headset, as described herein.

### DETAILED DESCRIPTION

In the following description of various implementations of a “Mixed-Reality Headset,” reference is made to the accompanying drawings, which form a part hereof, and in which is shown by way of illustration specific implementations in which the Mixed-Reality Headset may be practiced. Other implementations may be utilized and structural changes may be made without departing from the scope thereof.

Specific terminology will be resorted to in describing the various implementations described herein, and that it is not intended for these implementations to be limited to the specific terms so chosen. Furthermore, each specific term includes all its technical equivalents that operate in a broadly similar manner to achieve a similar purpose. Reference herein to “one implementation,” or “another implementation,” or an “exemplary implementation,” or an “alternate implementation” or similar phrases, means that a particular feature, a particular structure, or particular characteristics described in connection with the implementation can be included in at least one implementation of the Mixed-Reality Headset. Further, the appearance of such phrases throughout the specification are not necessarily all referring to the same implementation, and separate or alternative implementations are not mutually exclusive of other implementations. The order described or illustrated herein for any process flows representing one or more implementations of the Mixed-Reality Headset does not inherently indicate any requirement for the processes to be implemented in the order described or illustrated, and any such order described or illustrated herein for any process flows do not imply any limitations of the Mixed-Reality Headset.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” variants thereof, and other similar words are used in either this detailed description or the claims, these terms are intended to be inclusive in a manner similar to the term “comprising” as an open transition word without precluding any additional or other elements.

1.0 Introduction:

In general, a “Mixed-Reality Headset,” as described herein, provides an attachment or docking mechanism for a portable computing device. This enables the Mixed-Reality Headset to present augmented reality (AR) and/or virtual reality (VR) content via various combinations of headset optics with a display screen of the portable computing device. In various implementations, the Mixed-Reality Headset presents AR and VR content constructed and rendered in response to user movement and tracking (e.g., head, eye, hands, and body) and real-world object and environmental mapping based on various combinations of sensors.

Note that examples of portable computing devices operable with the Mixed-Reality Headset include, but are not limited to, smartphones, media players, gaming devices, mini-tablet type computers, eReaders, other small computing devices with integral display screens, or simply a display screen or device capable of receiving and presenting video content. However, for purposes of explanation, the following discussion will generally refer to the use of a smartphone coupled to the Mixed-Reality Headset for presentation of AR and VR content. Any discussion of smartphones in this context applies equally to some or all of the various portable computing devices operable with the Mixed-Reality Headset.

Advantageously, the Mixed-Reality Headset provides low cost, high performance, and easy to use AR and VR experiences with unmodified smartphone hardware. Consequently, the Mixed-Reality Headset improves user interaction and experience with smartphones by applying optical components of the headset to enable smartphones to present immersive AR and VR content. Further, by leveraging the smartphone display, and, optionally, sensors or computational functionality of the smartphone, various implementations of the Mixed-Reality Headset can be inexpensively manufactured with inert optics and few or no moving or electronically actuated components.

However, in further implementations, the Mixed-Reality headset includes various combinations of active components, which are also relatively inexpensive to manufacture. For example, as discussed in further detail herein, some of these active components include, but are not limited to, optical calibration controllers configured to adjust one or more headset optical components for adapting to user vision and/or adapting alignments of AR content to the visible real-world environment, mechanisms for controlling a transparency of various components of the headset to enable or block user frontal and/or peripheral vision, reflector controllers for activating and/or adjusting reflectors configured to redirect a field of view of one or more smartphone cameras, etc.

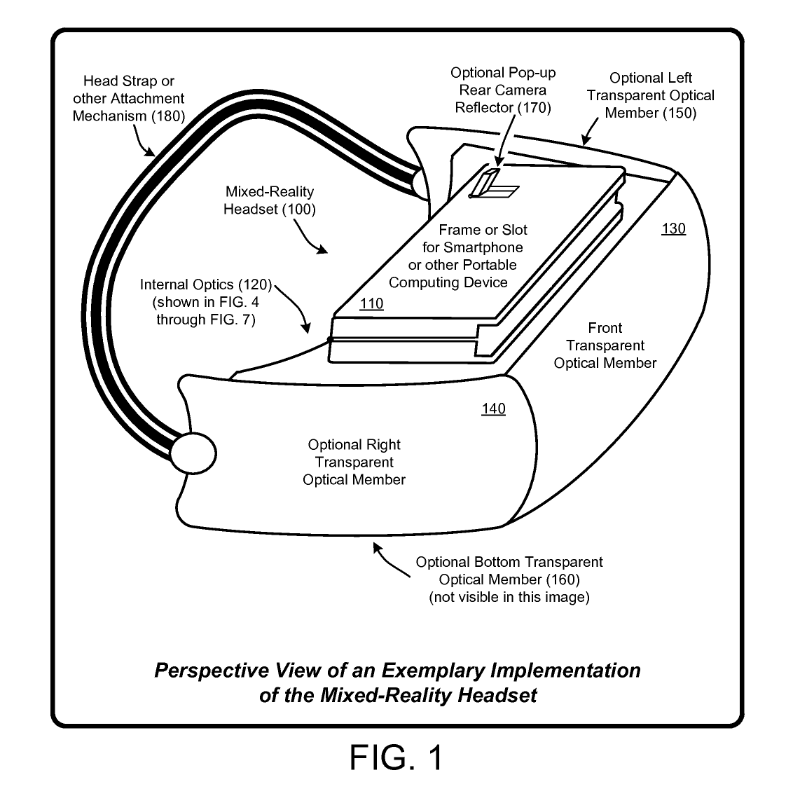

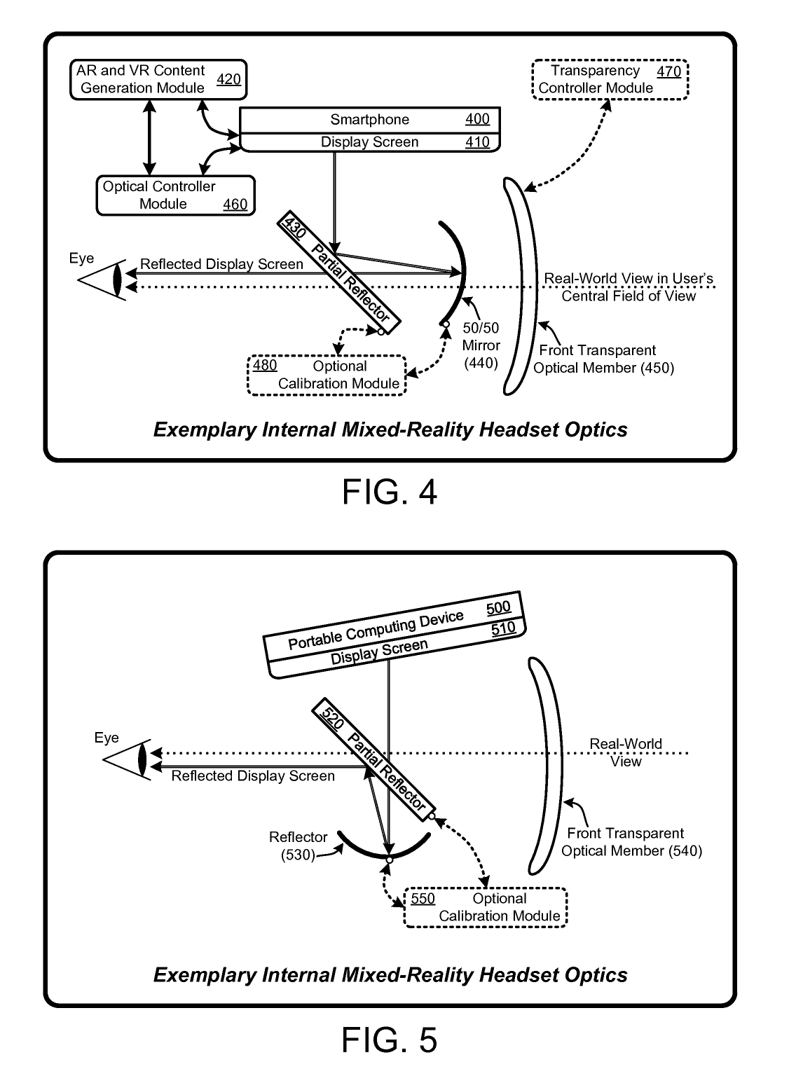

As illustrated by FIG. 1, various implementations of the Mixed-Reality Headset 100 include a frame or slot 110 or other attachment mechanism for coupling a smartphone or other portable computing device to the headset. The Mixed-Reality Headset 100 also includes various combinations of internal optics 120. These internal optics 120 are not shown in FIG. 1, but are illustrated in FIG. 4 through FIG. 7, as discussed in further detail herein.

As illustrated by FIG. 1, the frame or slot 110 or other attachment mechanism is configured to mount or attach the smartphone to the Mixed-Reality Headset 100 in a way that exposes a display screen of the smartphone to the internal optics 120 of the headset while ensuring that the smartphone is not blocking the user's central field of view. In other words, the central field of view of a user remains open to receiving views of the real world. Consequently, because the user's central field of view is not blocked by the smartphone, a front transparent optical member 130, which is configured to pass light (when in a transparent mode or state), enables a direct view of the real-world environment while the user is wearing the headset. Similarly, optional right, left and bottom transparent optical members (140, 150 and 160, respectively) are configured to pass light (when in a transparent mode or state) to enable a peripheral view of the real-world environment while the user is wearing the Mixed-Reality Headset 100. Consequently, the Mixed-Reality Headset 100 easily and quickly transitions between AR and VR scenarios by causing the transparent optical members to either pass light or block light, thereby either showing or hiding views of the real world while presenting virtual content to the user.

Another optional feature of the Mixed-Reality Headset 100 illustrated by FIG. 1 includes an optional pop-up or otherwise adjustable rear camera reflector 170. The rear camera reflector is configured to redirect a field of view of a rear camera of the smartphone (rear camera is facing approximately upwards when the smartphone is mounted in the Mixed-Reality Headset 100) to capture an approximately frontal field view relative to the user. Note that the total field of view visible to rear camera via the rear camera reflector 170 can be adapted to capture a wide range of field of views by configuring the reflector with any desired curvature and focal properties.

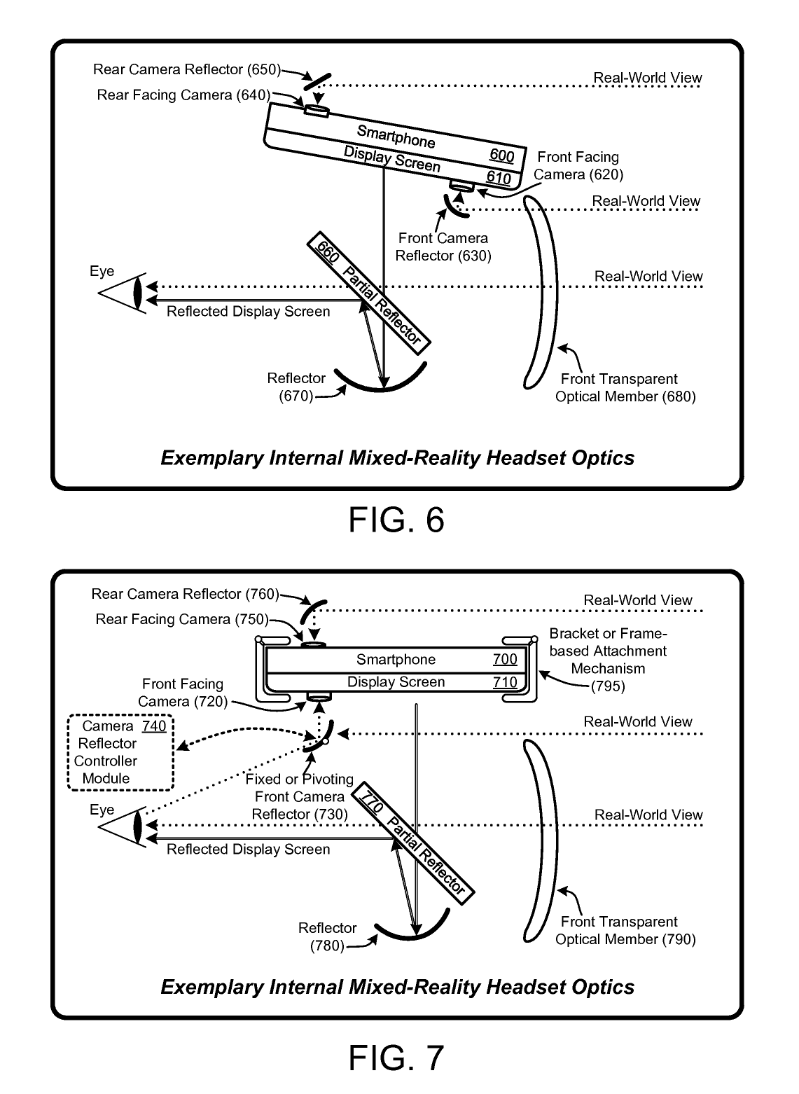

As illustrated by FIGS. 6 and 7, discussed in further detail herein, similar arrangements of reflective members are configured to enable a front camera of the smartphone to capture an approximately frontal field view relative to the user. The front camera may face approximately downwards into the Mixed-Reality Headset 100 when the smartphone is mounted to the headset. The optics of the front and rear cameras may be combined for various purposes including, but not limited to user and object tracking, stereo vision, etc. In other words, optional reflective members of the Mixed-Reality Headset 100 are configured to enable smartphone cameras to capture real-world environmental views around the user. Note that one or more of these cameras may also be configured to track user gaze or eye movements.

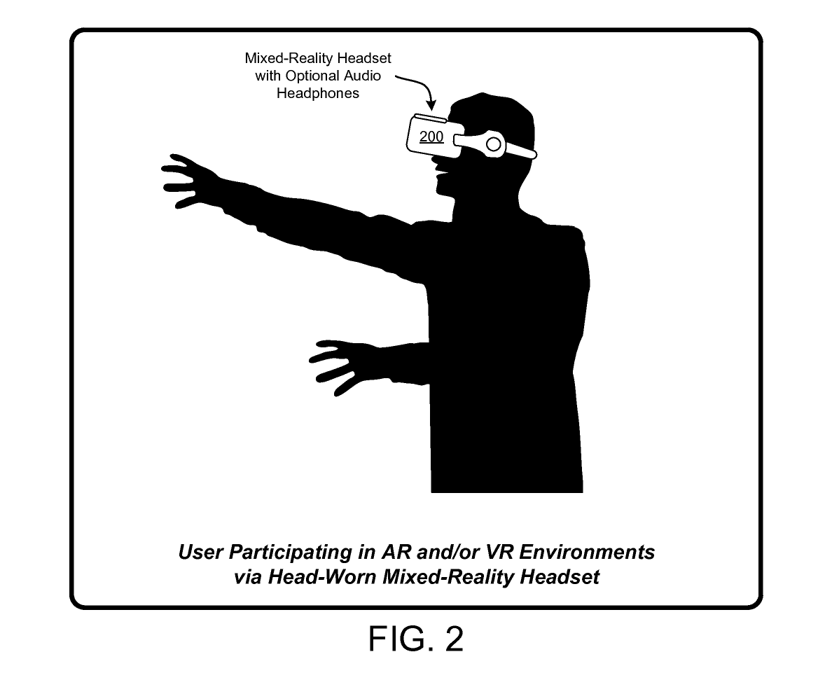

Finally, a head strap or other attachment mechanism 180 is provided to secure the Mixed-Reality Headset 100 to the user's head. For example, FIG. 2 shows a user wearing a different implementation of the Mixed-Reality Headset 200 that includes optional audio headphones while the user is participating in either or both AR and VR environments.

1.1 System Overview:

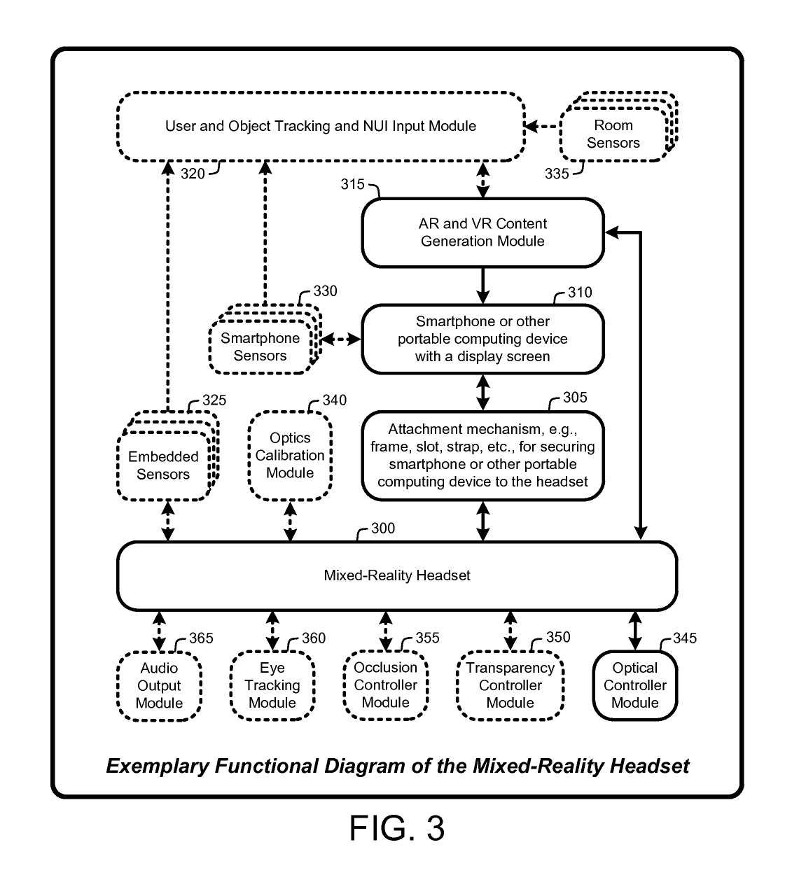

As noted above, the “Mixed-Reality Headset,” provides various techniques for enabling smartphones or other portable computing devices to present AR and/or VR experiences via various combinations of headset optics. The processes summarized above are illustrated by the general system diagram of FIG. 3. In particular, the system diagram of FIG. 3 illustrates the interrelationships between program modules for implementing various implementations of the Mixed-Reality Headset, as described herein. Furthermore, while the system diagram of FIG. 3 illustrates a high-level view of various implementations of the Mixed-Reality Headset, FIG. 3 is not intended to provide an exhaustive or complete illustration of every possible implementation of the Mixed-Reality Headset as described throughout this document.

Any boxes and interconnections between boxes that may be represented by broken or dashed lines in FIG. 3 represent alternate implementations of the Mixed-Reality Headset described herein, and that any or all of these alternate implementations, as described below, may be used in combination with other alternate implementations that are described throughout this document.

In general, as illustrated by FIG. 3, the processes provided by the Mixed-Reality Headset are enabled by coupling a smartphone to the headset in a way that enables light from the display of the smartphone to be redirected and reflected by internal headset optics for presenting both AR and VR content to the user. For example, in various implementations, a Mixed-Reality Headset 300 is configured with an attachment mechanism 305 such as a frame, a bracket, a forward-, rearward-, side- or top-facing slot, a strap, an elastic cord, a magnetic coupling, etc. This attachment mechanism is configured to secure a smartphone 310 or other portable computing device to the headset such that the display of the smartphone is exposed to the internal headset optics.

In operation, an AR and VR content generation module 315 renders AR and/or VR content to be displayed on the screen of the smartphone 310. In general, the AR and VR content generation module 315 is configured to execute on any of a variety of computational resources to render the AR and VR content. Examples of such computational resources include any or all of computational capabilities of the smartphone 310, local or remote computing resources, cloud-based computational resources, etc.

Further, in various implementations, the AR and VR provided by the AR and VR Content Generation Module 315 is configured to render and/or modify that content based on user and object tracking information and/or based on various natural user inputs (NUI) such as speech and gesture-based commands for interacting with the AR and VR content. More specifically, in various implementations, a user and object tracking and NUI input module 320 interprets sensor information received from a plurality of sensors for tracking and NUI input purposes. Examples of such sensors include, but are not limited to, optional embedded sensors 325 coupled to or embedded in the Mixed-Reality Headset 300, smartphone sensors 330 embedded in or coupled to the smartphone 310 or other computing device, and room sensors 335. In addition, user-worn sensors may also provide data for user and object tracking and NUI input purposes.

Examples of sensors that may be used for such purposes include, but are not limited to, GPS, proximity sensors (e.g., ultrasonic, capacitive, photoelectric, inductive, magnetic, RFID, etc.), motion sensors (e.g., visible light, infrared light, ultrasound, microwave, radar, accelerometers, inertial sensors, tilt sensors, etc.), image sensors, touch sensors, pressure sensors, microphones, compasses, low-power radio devices, temperature sensors, etc. Further, in the case of room-based sensors, sensor systems or suites, such as, for example, an OptiTrack™ motion capture system, a Kinect®-type system, etc., positioned within or throughout the real-world environment around the user may be applied to provide sensor data for tracking, motion capture, and NUI inputs. Note that the use of such sensors for tracking, motion capture, and NUI purposes is well known to those skilled in the art, and will not be described in detail herein. Regardless of the source (or multiple sources), this sensor data may be provided to the AR and VR Content Generation Module 315 for use in rendering virtual content.

In addition, in various implementations, the AR and VR content generation module communicates with an optical controller module 345 configured to align one or more virtual objects rendered on the display of the smartphone with one or more real-world objects visible through the partial reflector and the front transparent optical member of the Mixed-Reality Headset 300. As with the AR and VR Content Generation Module 315, the optical controller module 345 is configured to execute on any of a variety of computational resources. In various implementations, the optical controller module 345 operates as a per-eye controller configured to adapt AR and VR content to the different lines of sight of each individual eye (e.g., parallax). Consequently, the resulting AR and VR content may appear to have more sharply defined stereo or 3D features. Further, the resulting AR content will more closely match an intended real-world depth of objects and surfaces relative to which that AR content is being rendered.

In various implementations, a transparency controller module 350 is configured to control a transparency level of the front transparent member and the optional right, left and bottom transparent optical members. Transparency levels of any of these transparent optical members may be individually controlled, and can range from a maximum transparency (depending on the materials used) to a fully opaque state or level. In various implementations, this feature enables the Mixed-Reality Headset 300 to transition between AR and VR scenarios by causing the transparent optical members to either pass light or block light, thereby either showing or hiding views of the real world while presenting virtual content to the user.

Further, in various implementations, an occlusion controller module 355 is configured to selectively change transparency levels of one or more individual sub-regions of any or all of the transparent optical members. This enables a variety of effects, such as, for example, hiding a real-world object, surface, person, etc., by causing a corresponding sub-region of one of the transparent optical members to become partially or fully occluded. Note also that the AR and VR content generation module can then render virtual content to appear in corresponding locations via reflections of the smartphone display through the internal optics of the Mixed-Reality Headset 300.

In further implementations, an eye tracking module 360 applies internal optics of the Mixed-Reality Headset 300 that are configured to reflect a field of view of the forward facing camera of the smartphone to capture at least a portion of one or more of the user's eyes.

In addition, in various implementations, an audio output module 365 is configured to provide audio output associated with the AR and VR content, with a real-time communications session, or with other audio content. In various implementations, this audio output is provided via headphones, speakers, or other audio output mechanism coupled to the Mixed-Reality Headset 300.

2.0 Operational Details of the Mixed-Reality Headset:

The above-described program modules are employed for implementing various implementations of the Mixed-Reality Headset. As summarized above, the Mixed-Reality Headset provides various techniques for enabling smartphones or other portable computing devices to present AR and/or VR experiences via various combinations of headset optics. The following sections provide a detailed discussion of the operation of various implementations of the Mixed-Reality Headset described in Section 1 with respect to FIG. 1 through FIG. 3. In particular, the following sections provides examples and operational details of various implementations of the Mixed-Reality Headset, including:
Operational overview of the Mixed-Reality Headset;
Exemplary smartphone attachment mechanisms;
Internal headset optics; and
Transparent optical members.

2.1 Operational Overview:

The Mixed-Reality Headset-based processes described herein provide various techniques for enabling smartphones or other portable computing devices to present AR and/or VR experiences via various combinations of headset optics. In various implementations, the Mixed-Reality Headset is configured with internal optics using a classic optical “birdbath” configuration to achieve high brightness, and low distortion, of projected images (e.g., content reflected from the display to the user's eyes via a partial reflector that enables concurrent direct views of the real-world environment).

Further, because the display screen of that computing device is coupled to the Mixed-Reality Headset in a position that does not block the user's central field of view, the user may also view the real-world environment through transparent optical members of the Mixed-Reality Headset. In addition, by applying various simple dimming techniques (e.g., cross polarizers, overlapping slits, transparent LCD screens, electrochromic materials, etc.) to the transparent optical members, the Mixed-Reality Headset can quickly transition between AR and VR experiences. Consequently, the Mixed-Reality Headset may be configured to present any desired combination of AR and VR content that is rendered by any desired content generation mechanism or application.

Advantageously, in various implementations, low cost manufacture of the Mixed-Reality Headset is achieved by existing molding and coating techniques of low cost plastics or other moldable materials for embedding or directly molding fixed or adjustable internal optical elements into a housing or body of the Mixed-Reality Headset, which itself may be molded from inexpensive materials. As such, the Mixed-Reality Headset presents an inexpensive, easily manufactured device that improves user interaction and experience with smartphones and other portable computing devices by enabling such devices to present AR and VR content.

2.2 Exemplary Smartphone Attachment Mechanisms:

The Mixed-Reality Headset provides any of a variety of attachment mechanisms for coupling a smartphone, or other portable computing device, to the headset in a way that enables light from the display of the smartphone to be redirected and reflected by internal headset optics for presenting both AR and VR content to the user. In other words, regardless of the particular type of attachment mechanism is used to secure the smartphone to the Mixed-Reality Headset, there will be a clear optical path from the display of the smartphone to the internal headset optics without blocking the users central field of view.

For example, in various implementations, the Mixed-Reality Headset is configured with a frame-based attachment mechanism positioned above the user's central line of sight or field of view (e.g., see FIG. 1, discussed previously). This frame-based attachment mechanism is configured to securely and removably couple the smartphone to the headset so that user movement while wearing the headset is unlikely to dislodge the smartphone. Further, the frame-based attachment mechanism is configured such that a bottom portion of the frame-based attachment mechanism provides a clear optical path from the display of the smartphone to internal optics of the Mixed-Reality Headset.

In various implementations, the headset is configured with a removable frame-based attachment mechanism. This feature allows the Mixed-Reality Headset to be configured with any of a plurality of different frame-based attachment mechanisms, each configured for compatibility with a particular type or model of smartphone or other computing device. As such, the Mixed-Reality Headset may be compatible with any of a wide range of smartphones or other portable computing devices by simply using an implementation of the frame-based attachment mechanism that is compatible with the geometry of the particular smartphone or portable computing device.

In other implementations, the Mixed-Reality Headset is configured with a slot-based attachment mechanism (e.g., forward-, rearward-, side- or top-facing slots) that enables the user to simply slide the smartphone into the Mixed-Reality Headset where it is then removably locked into place. As with the frame-based attachment mechanism, the slot-based attachment mechanism is configured such that a bottom portion of the slot-based attachment mechanism provides a clear optical path from the display of the smartphone to internal optics of the Mixed-Reality Headset. In addition, in various implementations, as with the frame-based attachment mechanism, the slot-based attachment mechanism is removable and may be replaced with an implementation of the slot-based attachment mechanism that is compatible with the geometry of the particular smartphone or portable computing device available to the user.

Other examples of attachment mechanisms for securing the smartphone or other portable computing device to the headset includes, but are not limited to straps, elastic cords or bands, magnetic couplings, etc. In various implementations, each of these attachment mechanisms, or various corresponding portions of the body of the Mixed-Reality Headset may be configured to match the geometry of the particular smartphone or portable computing device available to the user.

2.3 Internal Headset Optics:

The Mixed-Reality Headset includes a variety of internal optics and transparent optical members that are configured to redirect images and/or video content being rendered on a display screen towards a central field of view of a user. Further, because the display screen is coupled to the Mixed-Reality Headset in a position that does not block the user's central field of view, the user may also view the real-world environment through transparent optical members of the Mixed-Reality Headset.

The following discussion provides a variety of some of the many possible implementations of the internal optics of the Mixed-Reality Headset with respect to FIG. 4 through FIG. 7. For purposes of simplicity, the housing or body of the Mixed-Reality Headset is omitted from FIG. 4 through FIG. 7. However, the optical components and elements shown in these figures are intended to be positioned within, and coupled to, the structure of the Mixed-Reality Headset, such as, for example, the headset shown in FIG. 1.

Further, the Mixed-Reality Headset is not limited to the use of birdbath type optical configurations or to any of the particular optical configurations illustrated by FIG. 4 through FIG. 7. In particular, the Mixed-Reality Headset may be configured with any optical elements that are positioned and adapted to reflect content from a display such that the reflected content is visible to a user without blocking a central field of view of the user relative to a real-world environment around the user.

In addition, for purposes of clarity, FIG. 4 through FIG. 7 illustrate the use of various optical paths for reflecting images or directly passing light to a single eye of a user. However, in order to present stereo or 3D AR and VR content to the user, the Mixed-Reality Headset may be configured with separate optical paths corresponding to a line of sight of each eye. As such, in the case of presentation of stereo or 3D content, each of a left and right half (or corresponding sub-regions) of the display screen of the smartphone will display similar (or potentially identical) content that may be shifted to account for the slightly different lines of sight of each individual eye (e.g., parallax). In other words, in various implementations, the Mixed-Reality Headset may contain per-eye optical paths having per-eye optical components. However, depending on the particular configuration of optical components, single instances of particular optical components (e.g., a single partial reflector positioned to directly reflect light from the smartphone display) may be sufficient to enable presentation of stereo or 3D content to the user. Further, in various implementations, the Mixed-Reality Headset may be configured present mono or 2D content to one or both eyes via separate or single optical paths corresponding to a particular eye.

Note also that the following discussion of FIG. 4 through FIG. 7 refers to the use of partial reflectors and 50/50 mirrors. Both of these optical elements are also known as optical beam splitters. Beam splitters may be configured to simultaneously reflect light and to allow light to pass through without changing a perceived angle of incidence of that light. As such, a viewer can simultaneously see light reflected by the beam splitter from some source (e.g., light from a display screen) while looking directly through the beam splitter. The various optical arrangements illustrated by FIG. 4 through FIG. 7 make use of various forms of beam splitters in various configurations.

For example, as illustrated by FIG. 4, in various implementations, the Mixed-Reality Headset includes a smartphone 400 having a display screen 410. An AR and VR content generation module 420 (executing on either the smartphone or on some other local or remote computing system) provides virtual content that is rendered to the display screen 410. The smartphone 400, and thus the display screen 410, is coupled to the Mixed-Reality Headset by an attachment mechanism (not shown) that exposes the display screen to a partial reflector 430 (also known as a beam-splitter).

Light emitted from the display screen 410 (e.g., AR and/or VR content) is reflected by the partial reflector 430 towards a 50/50 mirror 440 (also known as a partial reflector) that is positioned in front of a front transparent optical member 450. Alternatively, a polarized reflector may be used in place of the 50/50 mirror 440. As illustrated by the arrows showing light reflection paths in FIG. 4, the 50/50 mirror 440 is configured to reflect light from the display screen 410, received via reflection from the partial reflector 430, back through the partial reflector towards the user's eyes. Concurrently, light from the real-world environment around the user passes through the front transparent optical member 450 and then passes directly through both the 50/50 mirror 440 and the partial reflector 430 to provide a real-world view to the user's eyes.

In various implementations, a per-eye optical controller module 460 is configured to automatically or manually adapt or shift the content on the display screen 410 to control alignment, scaling, etc., of images on the display screen. This adaptation or shifting of the images on the display screen 410 may be used for a variety of purposes. For example, shifting or scaling of content being rendered on the display screen 410 enables virtual objects or other content on the display screen to be visibly aligned with real-world objects, people, surfaces, etc., of the real-world view visible to the user's eyes through the front transparent optical member 450.

As discussed in further detail herein, the front transparent optical member 450 may be fully transparent. However, in various implementations, a transparency controller module 470 is configured to manually or automatically (e.g., executing either on the smartphone or on some other local or remote computing system) adapt the transparency of the front transparent optical member 450. Such adaptations are enabled by partially occluding (e.g., semi-transparent), fully occluding, or selectively occluding (e.g., sub-region occlusions) the front transparent optical member 450. Side and bottom transparent optical members (not shown) may also be controlled via the transparency controller module 470 in the same manner as the front transparent optical member 450 to enable or disable user peripheral vision. Various techniques for controlling transparency levels of any of the transparent optical members are discussed in further detail in Section 2.4 of this document.

These transparency control features and capabilities enable the Mixed-Reality Headset to present various AR and VR effects and to quickly switch between AR and VR modes. For example, in the case that the front transparent optical member 450 is fully transparent, any content presented on the display screen 410 will be perceived by the user as AR content that appears to exist within the real world because the user will concurrently see both the AR content and a real world view through the front transparent optical member. Conversely, in the case that the front transparent optical member 450 is fully opaque, any content presented on the display screen 410 will be perceived by the user as VR content since the user will be unable to see a real world view through the fully opaque front transparent optical member.

In addition, in various implementations, an optional calibration module 480 is configured to provide manual or automatic (e.g., executing on either the smartphone or on some other local or remote computing system) adjustments (e.g., angle, curvature, focal distance, etc.) of one or more of the optical components. Such adjustments serve to adapt the Mixed-Reality Headset to the particular vision parameters of particular users. Examples of some of the particular vision parameters for which the optics of the Mixed-Reality Headset may be adapted include, but are not limited to, inter-pupillary distance of the user's eyes, focusing corrections for particular user vision characteristics, etc.

FIG. 5 illustrates another implementation of the optical components of the Mixed-Reality Headset. Note that for purposes of clarity, FIG. 5 does not illustrate several of the various components already described with respect to FIG. 4 (e.g., the AR and VR content generation module, the optical controller module, and the transparency controller module). However, the functionality of these components, similar to the functionality described with respect to FIG. 4, may be adapted for use with the optical components illustrated by FIG. 5.

For example, as illustrated by FIG. 5, in various implementations, the Mixed-Reality Headset includes a portable computing device 500 having a display screen 510 on which virtual content is being rendered. The portable computing device 500, and thus the display screen 510, is coupled to the Mixed-Reality Headset by an attachment mechanism (not shown) that exposes the display screen to a partial reflector 520. Light emitted from the display screen 510 (e.g., AR and/or VR content) passes through the partial reflector 520 to a reflector 530. As illustrated by the arrows showing light reflection paths in FIG. 5, the reflector 530 is configured to reflect light received through the partial reflector 520 back towards the partial reflector where that light is then further reflected towards the user's eyes. Concurrently, light from the real-world environment around the user passes through a front transparent optical member 540 and then passes directly through the partial reflector 520 to provide a real-world view to the user's eyes.

As with FIG. 4, in the example of FIG. 5, in the case that the front transparent optical member 540 is fully transparent, any content presented on the display screen 510 will be perceived by the user as AR content that appears to exist within the real world because the user will concurrently see both the AR content and a real world view through the front transparent optical member. Conversely, in the case that the front transparent optical member 540 is fully opaque, any content presented on the display screen 510 will be perceived by the user as VR content since the user will be unable to see a real world view through the fully opaque front transparent optical member.

Similarly, as with FIG. 4, in various implementations, the optical arrangement of FIG. 5 includes an optional calibration module 550 that is configured to provide manual or automatic (e.g., executing on either the smartphone or on some other local or remote computing system) adjustments (e.g., angle, curvature, focal distance, etc.) of one or more of the optical components. Again, such adjustments serve to adapt the Mixed-Reality Headset to the particular vision parameters of particular users.

FIG. 6 illustrates another implementation of the optical components of the Mixed-Reality Headset. For purposes of simplicity, FIG. 6 does not illustrate several of the various components already described with respect to FIG. 4 and/or FIG. 5 (e.g., the AR and VR content generation module, the optical controller module, the transparency controller module, and the optional calibration module). However, the functionality of these components, similar to the functionality described with respect to FIG. 4 and/or FIG. 5, may be adapted for use with the optical components illustrated by FIG. 6.

For example, as illustrated by FIG. 6, in various implementations, the Mixed-Reality Headset includes a smartphone 600 having a display screen 610 on which virtual content is being rendered. The smartphone 600, and thus the display screen 610, is coupled to the Mixed-Reality Headset by an attachment mechanism (not shown) that exposes the display screen to a partial reflector 660. As with the optical arrangement illustrated by FIG. 5, FIG. 6 shows that light emitted from the display screen 610 (e.g., AR and/or VR content) passes through the partial reflector 660 to a reflector 670. As illustrated by the arrows showing light reflection paths in FIG. 6, the reflector 670 is configured to reflect light received through the partial reflector 660 back towards the partial reflector where that light is then further reflected towards the user's eyes. Concurrently, light from the real-world environment around the user passes through a front transparent optical member 680 and then passes directly through the partial reflector 660 to provide a real-world view to the user's eyes.

As with FIG. 5, in the example of FIG. 6, in the case that the front transparent optical member 680 is fully transparent, any content presented on the display screen 610 will be perceived by the user as AR content that appears to exist within the real world since the user will concurrently see both the AR content and a real world view through the front transparent optical member. Conversely, in the case that the front transparent optical member 680 is fully opaque, any content presented on the display screen 610 will be perceived by the user as VR content because the user will be unable to see a real world view through the fully opaque front transparent optical member.

In addition, FIG. 6 illustrates both a front facing camera 620 and a rear facing camera 640 of the smartphone 600. In the example of FIG. 6, a front camera reflector 630 is configured to enable the front facing camera 620 to capture an approximately frontal real-world view relative to the user. Similarly, a rear camera reflector 650 is configured to redirect a field of view of the rear facing camera 640 to capture approximately the same frontal real-world as that of the front facing camera 620.

Consequently, because both the front facing camera 620 and the rear facing camera 640 are capable of capturing approximately the same field of view, the optics of the front and rear cameras may be combined for various purposes including, but not limited to user and object detection and tracking, stereo vision, scene understanding and modeling, alignment of virtual content to real-world objects and surfaces, etc. In addition, images captured by either or both cameras may be presented to the user. For example, images from these cameras may be used to enable various virtual optical zoom effects of real-world objects in the real-world environment or other virtual special effects based on real-time real-world imaging. The camera arrangement with front and rear camera reflectors (630 and 650) may also be applied with optics configurations such as those illustrated with respect to FIG. 4 and FIG. 5.

In various implementations, automatic or manual camera calibration is applied to improve operation of the Mixed-Reality Headset with a variety of different smartphones. However, the Mixed-Reality Headset may also be designed for a particular smartphone such that no calibration will be needed unless geometric or camera properties of that smartphone change. In the case that calibration is performed, initial software calibration procedures may be applied to compensate for distortion of images captured by either or both of the smartphone cameras via the front and rear camera reflectors.

More specifically, the use of camera reflectors to redirect the field of view of the front and/or rear facing cameras may introduce some amount of distortion to captured images that may be corrected via calibration parameters. For example, in various implementations, a reticle is placed in the field of view of the camera (e.g., a reticle etched into or otherwise added to one or both of the camera reflectors). Distortions of reticle images may be automatically corrected to correct underlying images of the real-world environment. Similarly, given known sizes and shapes of the reticle, and known camera parameters, the reticle may be used to both calibrate images captured by the camera and determine distances to real-world objects and surfaces. Unless images captured by the camera are displayed to the user for some reason, the reticle will not be visible to the user. In other implementations, a known target is placed a known distance from the cameras and imaged by those cameras via the front and/or rear reflectors. The resulting images may then be compared to the known target to generate corrective parameters that may then be applied to any other images captured by the cameras.

FIG. 7 illustrates another implementation of the optical components of the Mixed-Reality Headset that is similar to the configuration described with respect to FIG. 6. Note that for purposes of clarity, FIG. 7 does not illustrate several of the various components already described with respect to FIG. 4 and/or FIG. 5 (e.g., the AR and VR content generation module, the optical controller module, the transparency controller module, and the optional calibration module). However, the functionality of these components, similar to the functionality described with respect to FIG. 4 and/or FIG. 5, may be adapted for use with the optical components illustrated by FIG. 7.

For example, as illustrated by FIG. 7, in various implementations, the Mixed-Reality Headset includes a smartphone 700 having a display screen 710 on which virtual content is being rendered. The smartphone 700, and thus the display screen 710, is secured to or otherwise coupled to the Mixed-Reality Headset by an attachment mechanism 795 that exposes the display screen to a partial reflector 770. As with the optical arrangement illustrated by FIG. 5 and FIG. 6, FIG. 7 shows that light emitted from the display screen 710 (e.g., AR and/or VR content) passes through the partial reflector 770 to a reflector 780. As illustrated by the arrows showing light reflection paths in FIG. 7, the reflector 780 is configured to reflect light received through the partial reflector 770 back towards the partial reflector where that light is then further reflected towards the user's eyes. Concurrently, light from the real-world environment around the user passes through a front transparent optical member 790 and then passes directly through the partial reflector 770 to provide a real-world view to the user's eyes.

As with FIG. 5 and FIG. 6, in the example of FIG. 7, in the case that the front transparent optical member 790 is fully transparent, any content presented on the display screen 710 will be perceived by the user as AR content that appears to exist within the real world because the user will concurrently see both the AR content and a real world view through the front transparent optical member. Conversely, in the case that the front transparent optical member 790 is fully opaque, any content presented on the display screen 710 will be perceived by the user as VR content since the user will be unable to see a real world view through the fully opaque front transparent optical member.

In addition, as with FIG. 6, FIG. 7 illustrates both a front facing camera 720 and a rear facing camera 750 of the smartphone 700. In the example of FIG. 7, a front camera reflector 730 is configured as either a fixed or pivoting reflector that is automatically configurable via a camera reflector controller module 740 to enable the front facing camera 720 either to track user gaze or eye movements, or to capture an approximately frontal real-world view relative to the user. In further implementations, the front camera reflector 730 may be placed inline with the partial reflector 770 (configuration not shown in FIG. 7). Then, by switching between near and far focus, the Mixed-Reality Headset can quickly switch between tracking user gaze or eye movements and capturing an approximately frontal real-world view relative to the user.

Further, as with FIG. 6, the example of FIG. 7 shows a rear camera reflector 760 configured to redirect a field of view of the rear facing camera 750 to capture approximately the same frontal real-world as that of the front facing camera 720, thereby enabling features and capabilities similar to those described with respect to FIG. 6. Further, the camera arrangement with front and rear camera reflectors (730 and 760) and optional may also be applied with optics configurations such as those illustrated with respect to FIG. 4, FIG. 5 and FIG. 6.

2.4 Transparent Optical Members:

As noted above, in various implementations, the Mixed-Reality Headset includes a front transparent optical member and optional side and bottom transparent members. Also as noted above, transparency levels of each of these transparent optical members may be controlled in a range from fully transparent to fully opaque. Causing at least the front transparent optical member to transition from transparent to opaque can change an AR experience into a VR experience. In addition to changing transparency levels of entire transparent optical members, in various implementations, transparency levels of one or more sub-regions of these transparent optical members may be controlled in a range from fully transparent to fully opaque.

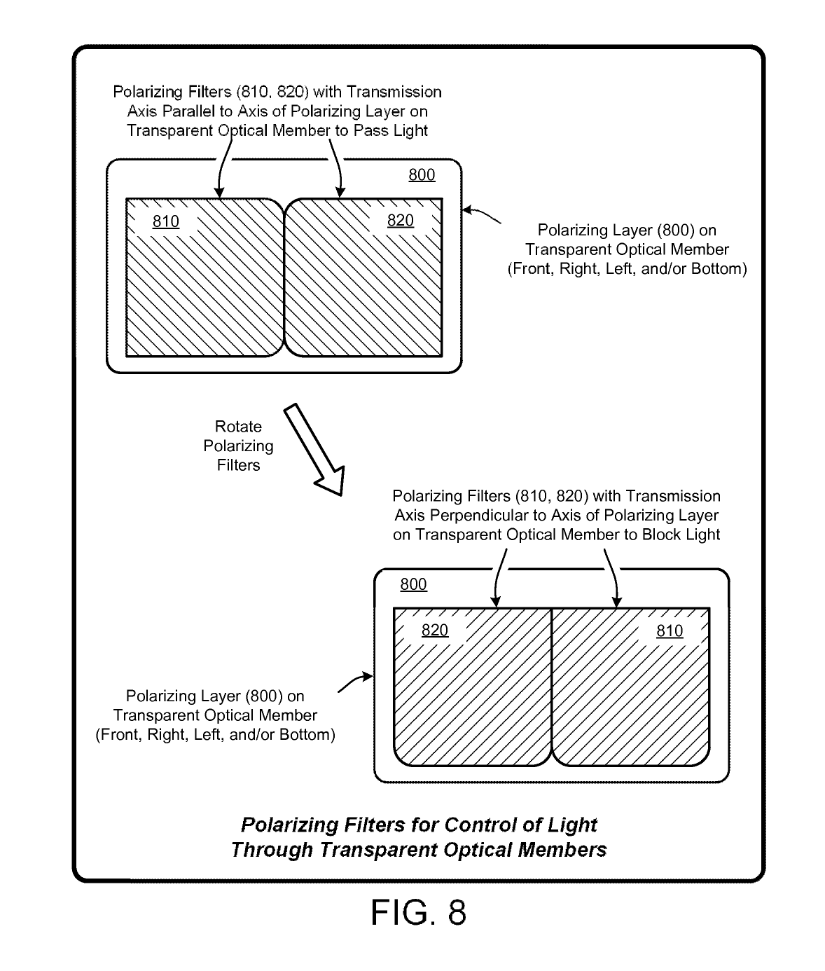

Any of a variety of techniques may be adapted for use in controlling transparency levels of any of the transparent optical members, thereby passing or blocking light from the real-world into the Mixed-Reality Headset. For example, as illustrated by FIG. 8, a polarizing layer 800 on any of the transparent optical members (e.g., front, right, left, and/or bottom) may be covered with separate polarizing filters (810, 820). In the case that the transmission axis polarizing filters (810, 820) is parallel to the transmission axis of the polarizing layer 800 on the transparent optical member, the transparent optical member will pass light from the real world environment into the internal optics of the Mixed-Reality Headset to provide a real-world view. Conversely, by rotating the polarizing filters (810, 820) such that the polarizing axis of the filters is perpendicular to the transmission axis of the polarizing layer 800 on the transparent optical member, the transparent optical member will block light from the real world environment into the internal optics of the Mixed-Reality Headset. Note also that partial rotation of the polarizing filters (810, 820) towards a relative perpendicular orientation enables reduction of light transmission without complete blockage.

Other examples of techniques that may be adapted for use in controlling transparency levels of any of the transparent optical members include, but are not limited to transparent LCD screens, SPD devices, electrochromic devices, micro-blinds, mechanical micro cross louvers, etc. For example, transparent LCD displays can be made transparent or opaque, and can be selectively dimmed to provide selective occlusions. As such, any of the transparent optical members may either be formed from, or fully or partially covered with, a transparent LCD display.

Similarly, a suspended particle device (SPD) may be applied to one or more of the transparent optical members. In general, an SPD involves a thin film laminate of rod-like nano-scale particles suspended in a liquid and placed between two transparent layers (e.g., glass or plastic) or attached to one layer of one or more of the transparent optical members. When no voltage is applied to the SPD, the suspended particles are randomly organized, thereby blocking light from the real world environment into the internal optics of the Mixed-Reality Headset. Conversely, when voltage is applied to the SPD, the suspended particles align and pass light from the real-world environment into the internal optics of the Mixed-Reality Headset. Varying the voltage of the film varies the orientation of the suspended particles, thereby regulating the tint of the glazing and the amount of light transmitted.

Similarly, in various implementations, an electrochromic layer of one or more of the transparent optical members may be applied to control light transmission properties of the transparent optical members in response to voltage inputs that are used to control transparency and opacity of the transparent optical members.

Similarly, micro-blinds etched into a layer or surface of one or more the transparent optical members may be applied to control light transmission properties of the transparent optical members in response to voltage input. Micro-blinds are sufficiently small that they are practically invisible to the eye. Micro-blinds are composed of rolled thin metal blinds that are typically deposited onto a transparent surface such as glass or plastic by magnetron sputtering and patterned by laser or lithography processes. The transparent surface includes a thin transparent conductive oxide (TCO) layer. In addition, a thin transparent insulator layer is deposited between the rolled metal layer and the TCO layer for electrical disconnection. With no applied voltage, the micro-blinds are rolled and therefore pass light from the real-world environment into the internal optics of the Mixed-Reality Headset. Conversely, when voltage is applied, a potential difference results between the rolled metal layer and the transparent conductive layer. As a result, the electric field formed by the application of the voltage causes the rolled micro-blinds to stretch out and thus block light from the real world environment.

3.0 Operational Summary of the Mixed-Reality Headset:

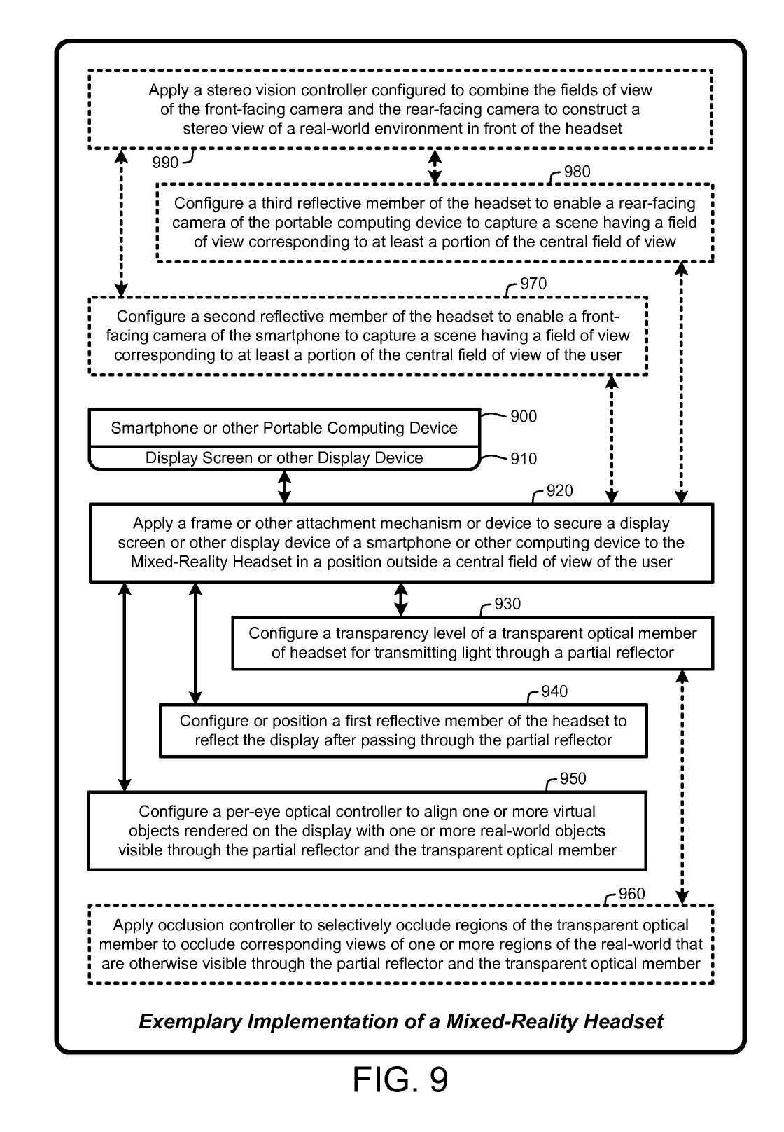

The processes described above with respect to FIG. 1 through FIG. 8, and in further view of the detailed description provided above in Sections 1 and 2, are illustrated by the general operational flow diagram of FIG. 9. In particular, FIG. 9 provides an exemplary operational flow diagram that summarizes the operation of some of the various implementations of the Mixed-Reality Headset. Note that FIG. 9 is not intended to be an exhaustive representation of all of the various implementations of the Mixed-Reality Headset described herein, and that the implementations represented in FIG. 9 are provided only for purposes of explanation.

Further, any boxes and interconnections between boxes that are represented by broken or dashed lines in FIG. 9 represent optional or alternate implementations of the Mixed-Reality Headset described herein, and that any or all of these optional or alternate implementations, as described below, may be used in combination with other alternate implementations that are described throughout this document.

In general, as illustrated by FIG. 9, various implementations of the Mixed-Reality Headset apply (920) a frame or other attachment mechanism or device to secure a display screen (910) or other display device of a smartphone (900) or other computing device to the Mixed-Reality Headset in a position outside a central field of view of the user. Further, the in various implementations, the Mixed-Reality Headset configures (930) a transparency level of a transparent optical member of the headset for transmitting light through a partial reflector. In addition, a first reflective member of the headset is configured (940) to reflect the display towards a user's field of vision after passing through the partial reflector. A per a per-eye optical controller (950) may then be configured to align one or more virtual objects rendered on the display with one or more real-world objects visible through the partial reflector and the transparent optical member.

In various implementations, the Mixed-Reality Headset applies an occlusion controller (960) to selectively occlude regions of the transparent optical member to occlude corresponding views of one or more regions of the real-world that are otherwise visible through the partial reflector and the transparent optical member.

In further implementations, a second reflective member of the headset is configured (970) to enable a front-facing camera of the smartphone to capture a scene having a field of view corresponding to at least a portion of the central field of view of the user. Similarly, in various implementations, a third reflective member of the headset is configured (980) to enable a rear-facing camera of the portable computing device to capture a scene having a field of view corresponding to at least a portion of the central field of view. Given the reflectors associated with the front-facing and rear-facing cameras, in various implementations, the Mixed-Reality Headset applies (990) a stereo vision controller configured to combine the fields of view of the front-facing camera and the rear-facing camera to construct a stereo view of a real-world environment in front of the headset.

4.0 Exemplary Implementations of the Mixed-Reality Headset:

The following paragraphs summarize various examples of implementations that may be claimed in the present document. The implementations summarized below are not intended to limit the subject matter that may be claimed in view of the detailed description of the Mixed-Reality Headset. Further, any or all of the implementations summarized below may be claimed in any desired combination with some or all of the implementations described throughout the detailed description and any implementations illustrated in one or more of the figures, and any other implementations and examples described below. The following implementations and examples are intended to be understood in view of the detailed description and figures described throughout this document.

In various implementations, a Mixed-Reality Headset is implemented by means, processes or techniques for providing a headset having an attachment or docking mechanism for a portable computing device in combination with various combinations of headset optics positioned relative to a display screen of the portable computing device. This enables the Mixed-Reality Headset to apply the display screen of the portable computing device to present either or both AR and VR content. The Mixed-Reality Headset presents an inexpensive, easily manufactured device that improves user interaction and experience with smartphones and other portable computing devices by enabling such devices to present AR and VR content.

As a first example, in various implementations, a device is implemented via means, processes or techniques for providing a headset including an attachment mechanism configured to secure a display to the headset in a position outside a central field of view of a user. In various implementations, a transparent optical member of the headset is configured to transmit light through a partial reflector of the headset. Further, in various implementations, a first reflective member of the headset is positioned to reflect the display after passing through the partial reflector. In addition, in various implementations, a per-eye optical controller configured to align one or more virtual objects rendered on the display with one or more real-world objects visible through the partial reflector and the transparent optical member.

As a second example, in various implementations, the first example is further modified via means, processes or techniques for providing an occlusion controller configured to selectively occlude one or more regions of the transparent optical member to selectively occlude corresponding views of one or more regions of the real-world that are otherwise visible through the partial reflector and the transparent optical member.

As a third example, in various implementations, any of the first example and the second example are further modified via means, processes or techniques for providing an opacity controller of the headset configured to adjust an opacity level of the transparent optical member.

As a fourth example, in various implementations, any of the first example, the second example, and the third example are further modified via means, processes or techniques for providing a side transparent member positioned on each of a left and right side of the headset configured to expand a total field of view beyond the central field of view, and wherein the opacity controller is further configured to adjust an opacity level of each side transparent member.

As a fifth example, in various implementations, any of the third example and the fourth example are further modified via means, processes or techniques for providing a reality type controller configured to transition between an augmented reality display and a virtual reality display by causing the opacity controller to adjust the opacity level of the transparent optical member.

As a sixth example, in various implementations, any of the third example, the fourth example and the fifth example, are further modified via means, processes or techniques for providing a bottom transparent member positioned on a bottom surface of the headset configured to expand a total field of view beyond the central field of view, and wherein the opacity controller is further configured to adjust an opacity level of the bottom transparent member.

As a seventh example, in various implementations, any of the first example, the second example, the third example, the fourth example, the fifth example and the sixth example, are further modified via means, processes or techniques for providing the display device coupled to a portable computing device.

As an eighth example, in various implementations, the seventh example is further modified via means, processes or techniques for providing an eye tracker configured to apply at least one camera of the portable computing device to track at least one of the user's eyes.

As a ninth example, in various implementations, any of the seventh example and the eighth example are further modified via means, processes or techniques for providing a second reflective member of the headset configured to enable a front-facing camera of the portable computing device to capture a scene having a field of view corresponding to at least a portion of the central field of view.

As a tenth example, in various implementations, any of the seventh example, the eighth example, and the ninth example, are further modified via means, processes or techniques for providing a third reflective member of the headset configured to enable a rear-facing camera of the portable computing device to capture a scene having a field of view corresponding to at least a portion of the central field of view.

As an eleventh example, in various implementations, the tenth example is further modified via means, processes or techniques for providing a stereo vision controller configured to combine the fields of view of the front-facing camera and the rear-facing camera to construct a stereo view of a real-world environment in front of the headset.

As a twelfth example, in various implementations, any of the tenth example and the eleventh example are further modified via means, processes or techniques for providing a head tracker configured to combine the fields of view of the front-facing camera and the rear-facing camera to track relative motions of the user's head.

As a thirteenth example, in various implementations, any of the tenth example, the eleventh example, and the twelfth example are further modified via means, processes or techniques for providing an environmental mapper configured to combine the fields of view of the front-facing camera and the rear-facing camera to perform environmental mapping of a real-world environment in front of the headset.

As a fourteenth example, in various implementations, a system is implemented via means, processes or techniques for providing a display screen coupled to a general purpose computing device. In various implementations, the system further includes an attachment mechanism for securing the general purpose computing device to a headset such that the display screen is exposed to internal optics of the headset and such that a central field of view remains open. In various implementations, the system further includes a partial reflector of the headset configured to pass light from content being rendered on the display screen to a first reflector of the headset. In various implementations, the first reflector of the headset is configured to reflect the light passed from the display to the central field of view. In various implementations, the system further includes a front transparent optical member of the headset with an adjustable transparency level, configured via a transparency controller, to pass light from a real-world environment through the partial reflector to the central field of view. In various implementations, the system further includes an optical controller configured to adapt the content being rendered on the display device to align one or more elements of the content with one or more real-world objects visible in the central field of view.

As a fifteenth example, in various implementations, the fourteenth example is further modified via means, processes or techniques for providing a second reflective member of the headset configured to enable a front-facing camera of the portable computing device to capture a scene having a field of view corresponding to at least a portion of the central field of view. Further, in various implementations, a third reflective member of the headset is configured to enable a rear-facing camera of the portable computing device to capture a scene having a field of view corresponding to at least a portion of the central field of view.

As a sixteenth example, in various implementations, the fifteenth example is further modified via means, processes or techniques for providing a camera reflector controller configured to adjust the second reflective member to enable the front-facing camera to track at least one of a user's eyes.

As a seventeenth example, in various implementations, any of the fourteenth example, the fifteen the example, and the sixteenth example are further modified via means, processes or techniques for transitioning the headset between presentations of augmented reality and virtual reality by applying the transparency controller to adjust the transparency level of the front transparent optical member from a transparent state to an opaque state.

As an eighteenth example, in various implementations, a method is implemented via means, processes or techniques for coupling a smartphone to a headset in a position outside a central field of view of a user. In various implementations, the method renders virtual content on a display of the smartphone. In various implementations, light corresponding to the virtual content from the display is passed through a partial reflector of the headset. In various implementations, the light passing through the partial reflector is then reflected from a first reflector into the central field of view. In various implementations, light from a real-world environment is directly passed through an adjustably transparent front transparent optical member through the partial reflector into the central field of view. In various implementations, one or more elements of the virtual content are adjusted to align those elements with one or more real-world objects visible in the real-world environment within the central field of view.

As a nineteenth example, in various implementations, the eighteenth example is further modified via means, processes or techniques for configuring a second reflective member of the headset to enable a front-facing camera of the smartphone to capture a scene having a field of view corresponding to at least a portion of the central field of view. In addition, a third reflective member of the headset is configured to enable a rear-facing camera of the portable computing device to capture a scene having a field of view corresponding to at least a portion of the central field of view.

As a twentieth example, in various implementations, any of the eighteenth example and the nineteenth example are further modified via means, processes or techniques for combining the fields of view of the front-facing camera and the rear-facing camera to perform 3D environmental mapping of a real-world environment in front of the headset, and adapting the virtual content to the environmental mapping of the real-world environment.

5.0 Exemplary Operating Environments:

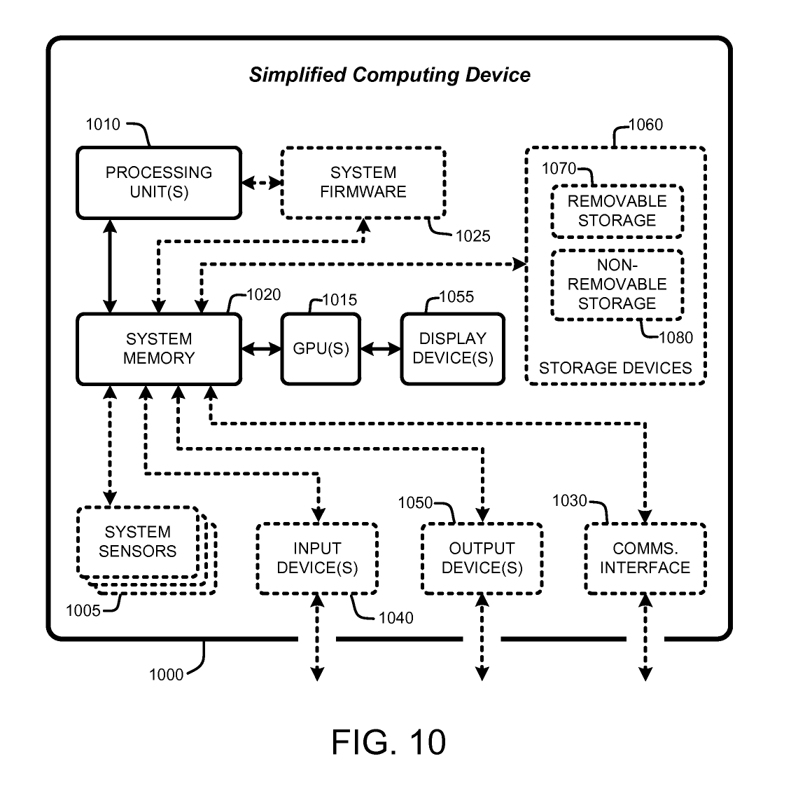

The Mixed-Reality Headset implementations described herein are operational within numerous types of general purpose or special purpose computing system environments or configurations. FIG. 10 illustrates a simplified example of a general-purpose computer system on which various implementations and elements of the Mixed-Reality Headset, as described herein, may be implemented. It is noted that any boxes that are represented by broken or dashed lines in the simplified computing device 1000 shown in FIG. 10 represent alternate implementations of the simplified computing device. As described below, any or all of these alternate implementations may be used in combination with other alternate implementations that are described throughout this document.

The simplified computing device 1000 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the Mixed-Reality Headset implementations described herein, the device should have a sufficient computational capability and system memory to enable basic computational operations. In particular, the computational capability of the simplified computing device 1000 shown in FIG. 10 is generally illustrated by one or more processing unit(s) 1010, and may also include one or more graphics processing units (GPUs) 1015, either or both in communication with system memory 1020. Note that that the processing unit(s) 1010 of the simplified computing device 1000 may be specialized microprocessors (such as a digital signal processor (DSP), a very long instruction word (VLIW) processor, a field-programmable gate array (FPGA), or other micro-controller) or can be conventional central processing units (CPUs) having one or more processing cores and that may also include one or more GPU-based cores or other specific-purpose cores in a multi-core processor.

In addition, the simplified computing device 1000 may also include other components, such as, for example, a communications interface 1030. The simplified computing device 1000 may also include one or more conventional computer input devices 1040 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 1000 and with any other component or feature of the Mixed-Reality Headset, including input, output, control, feedback, and response to one or more users or other devices or systems associated with the Mixed-Reality Headset, are enabled by a variety of Natural User Interface (NUI) scenarios. The NUI techniques and scenarios enabled by the Mixed-Reality Headset include, but are not limited to, interface technologies that allow one or more users user to interact with the Mixed-Reality Headset in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other input devices 1040 or system sensors 1005. Such NUI implementations are also enabled by the use of various techniques including, but not limited to, information derived from system sensors 1005 or other input devices 1040 from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited to, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the Mixed-Reality Headset.

However, the aforementioned exemplary NUI scenarios may be further augmented by combining the use of artificial constraints or additional signals with any combination of NUI inputs. Such artificial constraints or additional signals may be imposed or generated by input devices 1040 such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the Mixed-Reality Headset.

The simplified computing device 1000 may also include other optional components such as one or more conventional computer output devices 1050 (e.g., display device(s) 1055, audio output devices, video output devices, devices for transmitting wired or wireless data transmissions, and the like). Note that typical communications interfaces 1030, input devices 1040, output devices 1050, and storage devices 1060 for general-purpose computers are well known to those skilled in the art, and will not be described in detail herein.

The simplified computing device 1000 shown in FIG. 10 may also include a variety of computer-readable media. Computer-readable media can be any available media that can be accessed by the computing device 1000 via storage devices 1060, and include both volatile and nonvolatile media that is either removable 1070 and/or non-removable 1080, for storage of information such as computer-readable or computer-executable instructions, data structures, program modules, or other data.

Computer-readable media includes computer storage media and communication media. Computer storage media refers to tangible computer-readable or machine-readable media or storage devices such as digital versatile disks (DVDs), Blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various Mixed-Reality Headset implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware 1025, hardware, or any combination thereof to control a computer to implement the disclosed subject matter. The term “article of manufacture” as used herein is intended to encompass a computer program accessible from any computer-readable device, or media.

The Mixed-Reality Headset implementations described herein may be further described in the general context of computer-executable instructions, such as program modules, being executed by a computing device. Generally, program modules include routines, programs, objects, components, data structures, and the like, that perform particular tasks or implement particular abstract data types. The Mixed-Reality Headset implementations may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), and so on.

6.0 Other Implementations:

The foregoing description of the Mixed-Reality Headset has been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate implementations may be used in any combination desired to form additional hybrid implementations of the Mixed-Reality Headset. It is intended that the scope of the Mixed-Reality Headset be limited not by this detailed description, but rather by the claims appended hereto. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of detailed description of the Mixed-Reality Headset described above.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known to enable such interactions.

What is claimed is:

1. A device comprising:
a headset;
an attachment mechanism configured to secure a display to the headset in a position outside a central field of view of a user;
a transparent optical member of the headset configured to transmit light through a partial reflector of the headset;
a first reflective member of the headset positioned to reflect the display after passing through the partial reflector; and
a per-eye optical controller configured to align one or more virtual objects rendered on the display with one or more real-world objects visible through the partial reflector and the transparent optical member.

2. The device of claim 1 further comprising an occlusion controller for selectively occluding one or more regions of the transparent optical member to selectively occlude corresponding views of one or more regions of the real-world that are otherwise visible through the partial reflector and the transparent optical member.

3. The device of claim 1 further comprising an opacity controller of the headset configured to adjust an opacity level of the transparent optical member.

4. The device of claim 1 further comprising:
a side transparent member positioned on each of a left and right side of the headset configured to expand a total field of view beyond the central field of view; and
wherein the opacity controller is further configured to adjust an opacity level of each side transparent member.

5. The device of claim 3 further comprising a reality type controller configured to transition between an augmented reality display and a virtual reality display by causing the opacity controller to adjust the opacity level of the transparent optical member.

6. The device of claim 3 further comprising:
a bottom transparent member positioned on a bottom surface of the headset configured to expand a total field of view beyond the central field of view; and
wherein the opacity controller is further configured to adjust an opacity level of the bottom transparent member.

7. The device of claim 1 wherein the display device is coupled to a portable computing device.

8. The device of claim 7 further comprising an eye tracker configured to apply at least one camera of the portable computing device to track at least one of the user's eyes.

9. The device of claim 7 further comprising a second reflective member of the headset configured to enable a front-facing camera of the portable computing device to capture a scene having a field of view corresponding to at least a portion of the central field of view.

10. The device of claim 9 further comprising a third reflective member of the headset configured to enable a rear-facing camera of the portable computing device to capture a scene having a field of view corresponding to at least a portion of the central field of view.

11. The device of claim 10 further comprising a stereo vision controller configured to combine the fields of view of the front-facing camera and the rear-facing camera to construct a stereo view of a real-world environment in front of the headset.

12. The device of claim 10 further comprising a head tracker configured to combine the fields of view of the front-facing camera and the rear-facing camera to track relative motions of the user's head.

13. The device of claim 10 further comprising an environmental mapper configured to combine the fields of view of the front-facing camera and the rear-facing camera to perform environmental mapping of a real-world environment in front of the headset.

14. A system, comprising:
a display screen coupled to a general purpose computing device;
an attachment mechanism for securing the general purpose computing device to a headset such that the display screen is exposed to internal optics of the headset and such that a central field of view remains open;
a partial reflector of the headset configured to pass light from content being rendered on the display screen to a first reflector of the headset;
the first reflector of the headset configured to reflect the light passed from the display to the central field of view;
a front transparent optical member of the headset with an adjustable transparency level, configured via a transparency controller, to pass light from a real-world environment through the partial reflector to the central field of view; and
an optical controller configured to adapt the content being rendered on the display device to align one or more elements of the content with one or more real-world objects visible in the central field of view.

15. The system of claim 14 further comprising:
a second reflective member of the headset configured to enable a front-facing camera of the portable computing device to capture a scene having a field of view corresponding to at least a portion of the central field of view; and
a third reflective member of the headset configured to enable a rear-facing camera of the portable computing device to capture a scene having a field of view corresponding to at least a portion of the central field of view.

16. The system of claim 15 further comprising a camera reflector controller configured to adjust the second reflective member to enable the front-facing camera to track at least one of a user's eyes.

17. The system of claim 14 further comprising transitioning the headset between presentations of augmented reality and virtual reality by applying the transparency controller to adjust the transparency level of the front transparent optical member from a transparent state to an opaque state.

18. A method, comprising:
coupling a smartphone to a headset in a position outside a central field of view of a user;
rendering virtual content on a display of the smartphone;
passing light corresponding to the virtual content from the display through a partial reflector of the headset;
reflecting the light passing through the partial reflector from a first reflector into the central field of view;
passing light through an adjustably transparent front transparent optical member directly from a real-world environment through the partial reflector into the central field of view; and
adjusting one or more elements of the virtual content to align those elements with one or more real-world objects visible in the real-world environment within the central field of view.

19. The method of claim 18 further comprising:
configuring a second reflective member of the headset to enable a front-facing camera of the smartphone to capture a scene having a field of view corresponding to at least a portion of the central field of view; and
configuring a third reflective member of the headset to enable a rear-facing camera of the portable computing device to capture a scene having a field of view corresponding to at least a portion of the central field of view.

20. The method of claim 18 further comprising:
combining the fields of view of the front-facing camera and the rear-facing camera to perform 3D environmental mapping of a real-world environment in front of the headset; and
adapting the virtual content to the environmental mapping of the real-world environment.
